(19) United States
(12) Patent Application Publication
(10) Pub. No.: US 2002/0141420 A1
(43) Pub. Date: Oct. 3, 2002

(54) Throttling control system and method

(76) Inventor: Basuki Afandi Sugiarto, San Diego, CA (US)

Correspondence Address: SKJERVEN MORRILL LLP, 25 METRO DRIVE, SUITE 700, SAN JOSE, CA, 95110, US

(21) Appl. No.: 09/822,543

(22) Filed: Mar. 30, 2001

(51) Int. Cl. H04L 12/66; H04L 12/56; H04J 3/22

(52) U.S. Cl. 370/401; 370/329; 370/466; 370/352

(57) ABSTRACT

A throttling control system according to the invention provides broadband Internet access via a wireless infrastructure. In the system, subscribers use wireless modems coupled to computers, such as a desktop, laptop or handheld computer, to access the Internet. A wholesaler that manages base stations and routers may lease available signal bandwidth to a plurality of resellers/ISPs, which sell Internet services to subscribers. The throttling control system may be used to ensure each router provides pre-determined signal bandwidth limits for each ISP and its subscribers.

### BACKGROUND OF THE INVENTION

1. Field of the Invention

The present invention relates to communication systems, and more particularly, to controlling data packet transmission.

2. Description of the Related Art

Computers with modems may communicate with a base station and a router, which communicates with an Internet Service Provider (ISP) via a wired communication path. Tunneling refers to providing a secure temporary path over an Internet communication path.

### SUMMARY OF THE INVENTION

A throttling control system and method are provided in accordance with the present invention. A throttling control system according to the invention provides broadband Internet access via a wireless infrastructure. In the system, subscribers use wireless modems coupled to computers, such as a desktop, laptop or handheld computer, to access the Internet. A wholesaler that manages base stations and routers may lease available signal bandwidth to a plurality of resellers/ISPs, which sell Internet services to subscribers. The throttling control system may be used to ensure each router provides predetermined signal bandwidth limits for each ISP and its subscribers.

One advantage of the system is enforcing Differentiated Level of Service (DLS) agreements between the wholesaler and the ISPs.

Another advantage of the system is helping each reseller control the amount of bandwidth that is leased to their subscribers and prevent over-subscription.

One aspect of the invention relates to a system for controlling signal transmission between a plurality of modems coupled to computers and at least two Internet service providers. The system comprises a router and a tunnel switch. The router is coupled to a base station, which is configured to transmit and receive wireless signals to and from the modems coupled to computers. The tunnel switch is in communication with the router via a communication path. The router is configured to route signals between the base station and the tunnel switch via the communication path. The tunnel switch is configured to route signals between the router and first and second Internet service providers via wired communication paths. The router is configured to impose a first predetermined signal bandwidth limit between the modems and the first Internet service provider. The router is configured to impose a second pre-determined signal bandwidth limit between the modems and the second Internet service provider.

Another aspect of the invention relates to a method of controlling signal transmission between a plurality of modems coupled to computers and at least two Internet service providers. The method comprises wirelessly transmitting signals between a base station and the modems coupled to computers; routing signals between a router coupled to the base station and a tunnel switch via a communication path; routing signals between the tunnel switch and first and second Internet service providers via wired communication paths; imposing a first pre-determined signal bandwidth limit between the modems and the first Internet service provider; and imposing a second predetermined signal bandwidth limit between the modems and the second Internet service provider.

### BRIEF DESCRIPTION OF THE DRAWINGS

FIG. 1 illustrates one embodiment of a system with a wholesaler and a plurality of computers and ISPs/resellers.

FIG. 2 illustrates one embodiment of the system of FIG. 1, where a second ISP has more subscribers than a first ISP near a wholesaler's base station.

FIG. 3 illustrates one embodiment of a system in accordance with the present invention.

### DETAILED DESCRIPTION

A throttling control system and method according to the invention may be implemented in a system that provides instantaneous and continuous Internet access via a wireless infrastructure. In the system, subscribers may use wireless modems coupled to computers, such as a desktop, laptop or handheld computer (or purchase a computer with a built-in wireless modem), subscribe to an ISP's service, and have wireless Internet access activated instantaneously. The system may use broadband or narrowband communication systems, e.g., Cellular Digital Packet Data (CDPD). In one embodiment, the system uses i-BURST™, a personal broadband wireless Internet access system developed by ArrayComm in San Jose, Calif. In other embodiments, the system does not use i-BURST™.

For the system to provide broadband wireless coverage throughout United States, deployment and control of base stations will be very important. In one embodiment, the system enables each user to have, for example, a 1 Megabit/second bandwidth access to the Internet, and each base station will be able to support, for example, 40 Megabits/second or more of aggregate throughput. Thus, each base station can handle 40 or more concurrent network activities at a given time in this embodiment.

The system infrastructure comprises a network provider (also called a wholesaler) and one or more Internet service providers (ISPs or resellers), such as Sony Corporation. The wholesaler deploys and manages both wireless and wired network components of the system. The wholesaler can sell or lease bandwidth and geographic coverage as commodities to one or more resellers. Each reseller may market a broadband Internet connection service to a plurality of subscribers using the reseller's own brand and image.

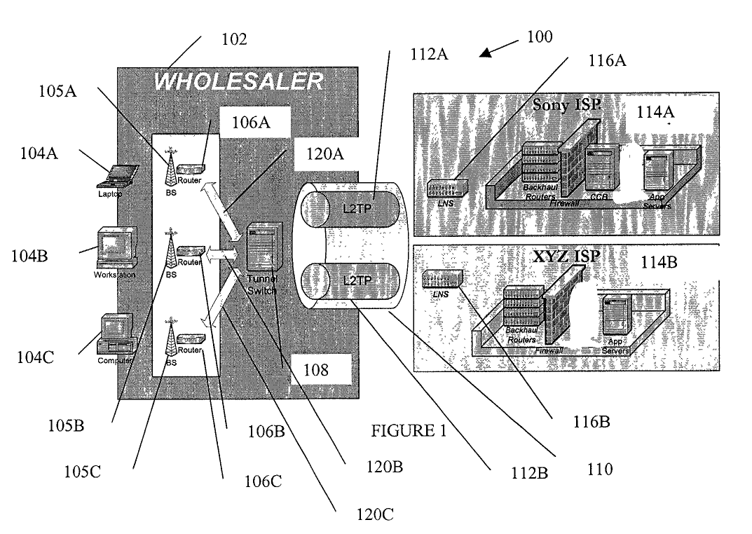

FIG. 1 illustrates one embodiment of a system 100 with a wholesaler 102 and a plurality of computers 104A-104C and ISPs/resellers 114A, 114B. The wholesaler 102 in FIG. 1 comprises a plurality of base stations (BS) 105A-105C (referred to herein individually or collectively as ‘base station 105’), routers 106A-106C (referred to herein individually or collectively as ‘router 106’), communication paths 120A-120C (referred to herein individually or collectively as ‘communication path 120’), and a tunnel switch 108. The system 100 in FIG. 1 may comprise any number of computers 104, base stations 105, routers 106, tunnel switches 108 and ISPs 114.

A first computer 104A in FIG. 1 may be a laptop. Second and third computers 104B-104C may be workstation or desktop computers. In other embodiments, the computers 104A-104C may be personal digital assistants (PDAs), such as a PalmPilot® PDA, home appliances, audio/video devices or mobile phones. Each computer 104 is coupled to a wireless modem (not shown) or has a built-in wireless modem.

Each wireless modem may or may not use access numbers. Each wireless modem is configured to transmit and receive signals with a base station 105 via an analog or digital wireless communication standard, such as Global System for Mobile Communications (GSM) or Code Division Multiple Access (CDMA). The signals from each computer 104 with a wireless modem to a base station 105 may comprise an email or a request for Internet content, such as a motion picture, a music video or a video game. The signals from a base station 105 to a computer 104 may comprise an email or Internet content, such as a motion picture, a music video or a video game.

Each base station 105 in FIG. 1 is a physical device that provides wireless communications between the computers 104A-104C and the ISPs 114A-114B. Each base station 105 may be referred to as a first aggregation point of connectivity for different modem terminals. In one embodiment, each base station 105 may maintain substantially continuous wireless communication channels with modems coupled to the computers 104A-104C, which are within a communication range of the base station 105. Thus, the communication channel between the computers 104A-104C and the base station 105 may be referred to as ‘always on,’ even when a user is not actively using a computer 104. In one embodiment, the system 100 uses ‘i-BURST™,’ a personal broadband wireless Internet access system developed by ArrayComm in San Jose, Calif.

Each router 106 in FIG. 1 may be implemented at a base station 105, coupled to a base station 105 or in communication with a base station 105. The router 106 may be manufactured by companies such as Cisco Systems, Inc., Nortel Networks, 3Com or Lucent Technologies. Each router 106 routes data packets between a base station 105 and the corresponding tunnel switch 108 via the communication paths 120A-120C.

The communication paths 120A-120C may comprise physical media, such as one or more twisted wire pair cables, coaxial cables or fiber optic cable, which may use a communication standard or protocol, such as T-1, Digital Service 3 (DS-3) or DS-4. Alternatively, the communication paths 120A-120C may be wireless. The paths 120A-120C carry data packets between the routers 106A-106C and the tunnel switch 108. Data packets from the routers 106A-106C to the tunnel switch 108 (i.e., from the user computers 102A-104C to an ISP 114) are herein referred to as ‘upstream.’ Data packets from the tunnel switch 108 to the routers 106A-106C (i.e., from an ISP 114 to the user computers 104A-104C) are referred to as ‘downstream.’

The tunnel switch (TS) 108 in FIG. 1 is an aggregation point that is configured to manage data packets from a number of different base stations 105A-105C. The TS 108 also directs signal traffic between the subscriber computers 104A-104C and corresponding resellers/ISP's 114A-114B via a wired communication path 110. In one embodiment, the TS 108 uses a first Layer 2 Tunneling Protocol (L2TP) 112A to direct subscribers' signal traffic to the first ISP 114A and a second L2TP 112B to direct subscribers' signal traffic to the second ISP 114B. L2TP is a protocol being developed by the Internet Engineering Task Force (IETF) to provide secure, high-priority, temporary paths through the Internet network.

Each ISP 114 in FIG. 1 has a L2TP network server (LNS) 116 for every TS 108. Each LNS 116 will decapsulate L2TP packets and perform Authentication, Authorization and Accounting (AAA) functions for each data packet entering the ISP network.

The wholesaler 102 in FIG. 1 may lease a percentage of the total available bandwidth of the wholesaler's base stations 105A-105C to a plurality of resellers/ISPs 114A-114B according to Differentiated Level of Service (DLS) agreements. A DLS agreement is an agreement between a provider and a customer, in which the provider guarantees a certain level of service will be available to the customer. A first level of service between the provider and a first customer may be different than a second level of service between the provider and a second customer. For wireless broadband communication services, there are two types of DLS agreements: a DLS agreement between the wholesale 102 and a reseller 114, and a DLS agreement between a reseller 114 and an end consumer with a computer 104.

For example, the wholesaler 102 may lease 75% of the wholesaler's total available bandwidth (upstream, downstream or both) to a first reseller 114A, such as Sony Corporation, according to a first DSL agreement. In one embodiment, each base station 105 provides a total bandwidth of 40 Megabits/second. The limiting factor for a given base station 105 in FIG. 1 is the aggregate signal traffic throughput, which in this embodiment is 40 Megabits/second. In this embodiment, Sony Corporation and its Internet service subscribers would ideally be able to use a bandwidth of 30 Megabits/second of each base station 105 of the wholesaler 102. The remaining 25% of available bandwidth (10 Megabits/second) may be leased to another reseller(s), such as the second reseller 114B in FIG. 1, according to a second DSL agreement.

If each subscriber computer 104 has a one Megabit/second broadband capacity, Sony Corporation would ideally be able to provide simultaneous connections for up to 30 subscribers at a given base station 105, and XYZ would ideally be able to provide simultaneous connections for up to 10 subscribers. When the wholesaler 102 leases available bandwidth as a commodity to interested resellers 114A, 114B, the wholesaler 102 should ensure that the leased bandwidth according to the DLS agreements is available 24 hours, seven days a week.

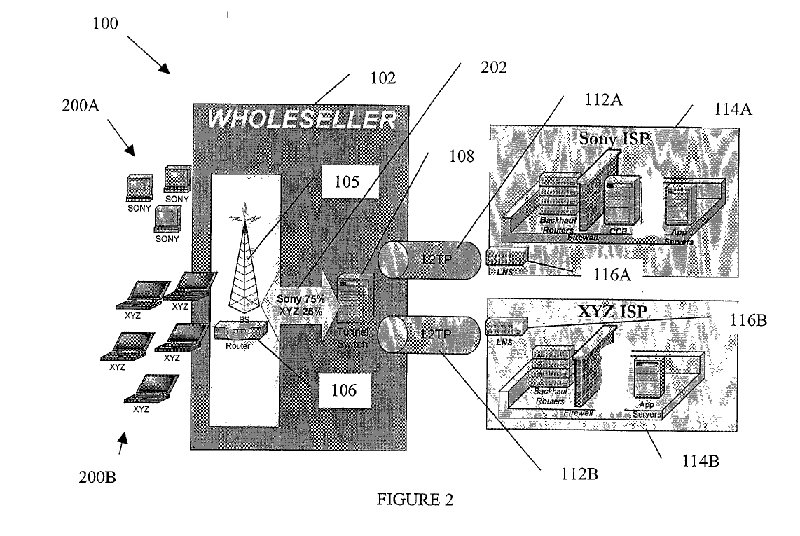

FIG. 2 illustrates one embodiment of the system 100 of FIG. 1 where a second ISP 114B has more subscribers 200B (referred to herein individually or collectively as 200B) than a first ISP 114A near a wholesaler's base station 105. The communication path 202 in FIG. 2 is substantially similar to a communication path 120 in FIG. 1. Ideally, using the example above, up to 75% of the traffic signal bandwidth of the communication path 202 between the router 106 and the tunnel switch 108 should be available for the first reseller 114A and its subscribers 200A (referred to herein individually or collectively as 200A). In FIG. 2, a reseller ‘throttling’ problem occurs when the second reseller's subscribers 200B consume more bandwidth at the base station 105 than the bandwidth allocated to the second reseller 114B, according to a DLS lease agreement between the second reseller 114B and the wholesaler 102. Other resellers, such as the first reseller 114A, with subscribers near the base station 105 may be compromised.

In one example, the second reseller 114B has more than 10 subscribers 200B (FIG. 2) near a base station 105, such as 15 subscribers, where each subscriber consumes at least one Megabit/second, regardless of how many subscribers 200A of the first reseller 114A are near the base station 105.

In another example, the second reseller 114B has less than 10 subscribers 200B near a base station 105, but the subscribers 200B collectively use more than 10 Megabits/second, regardless of how many subscribers 200A of the first reseller 114A are near the base station 105. In these two examples, the subscribers 200B of the second reseller 114B are using more bandwidth than the bandwidth allocated in the DSL lease agreement between the second reseller 114B and the wholesaler 102. The first reseller 114A and its subscribers 200A are not receiving their allocated 30 Megabits/second bandwidth according to the DSL agreement between the wholesaler 102 and the first reseller 114A.

In accordance with the present invention, every router 106 (and/or base station 105) is modified to enforce the available upstream bandwidths allocated by multiple DLS lease agreements. Similarly, the tunnel switch 108 may be modified to enforce the available downstream bandwidths allocated by multiple DLS lease agreements. The wholesaler components (base station 105, router 106 and TS 108) and the resellers' LNS 116A, 116B represent intermediate medium, which act as data carriers. The characteristics of network protocols, such as Transmission Control Protocol (TCP) and User Datagram Protocol (UDP), are based upon client/server architecture. Thus, the intermediate medium may be modified without affecting the data packets themselves.

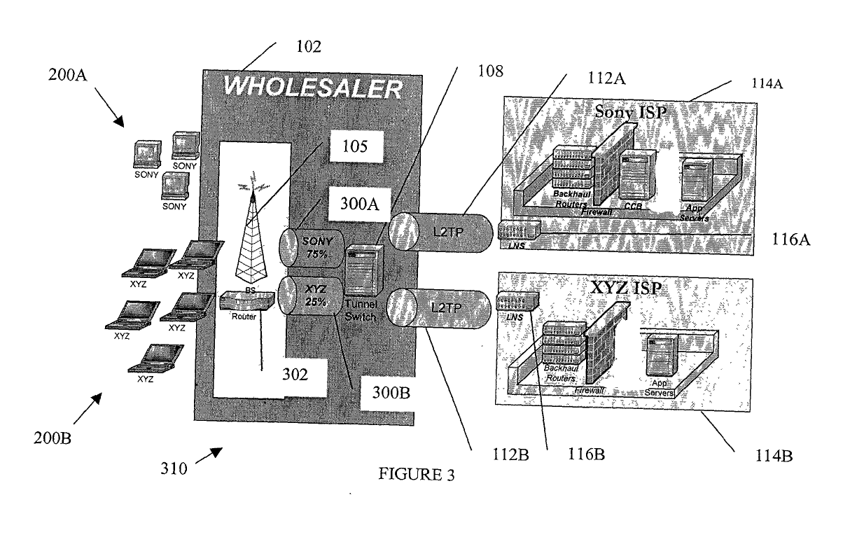

FIG. 3 illustrates one embodiment of a system 310 in accordance with the present invention. FIG. 3 illustrates a communication path 300 that may be considered as two logical communication paths 300A, 300B (referred to herein collectively or individually as ‘communication path 300’). The communication path 300 in FIG. 3 is substantially similar to a communication path 120 in FIG. 1, except for the distinctions described below. In one embodiment, the communication path 300 is implemented with a single physical medium, such as a cable. In another embodiment, the communication path 300 is implemented with more than one physical media. In another embodiment, the communication path 300 is implemented wirelessly.

The router 302 in FIG. 3 uses separate bandwidth limiting ‘interfaces’ to direct upstream signal traffic, which is intended for separate resellers 114A, 114B, between the router 302 and the tunnel switch 108 via communication paths 300A, 300B. Each interface creates a bandwidth limiting factor or ‘bottleneck’ to control signal traffic between the router 302 and the tunnel switch 108. Each interface may be implemented in software, hardware or a combination of software and hardware. There may be any number of interfaces. In one embodiment, the router 302 uses 100 interfaces for 100 ISPs 114. In FIG. 3, the router 302 uses a first interface to direct upstream signal traffic to the first reseller 114A and a second interface to direct upstream signal traffic to the second reseller 114. Each interface imposes a bandwidth allocation according to a DLS agreement between a reseller 114 and the wholesaler 102.

For example, the router 302 in FIG. 3 uses the first interface to carry signal traffic (intended for the first reseller 114A) to the tunnel switch 108 using 75% of the total bandwidth capacity of the communication path 300, which is 30 Mbits/sec of a total 40 Mbits/sec bandwidth. The router 108 in FIG. 3 uses the second interface to carry signal traffic (intended for the second reseller 114B) to the tunnel switch 108 using 25% of total bandwidth capacity, which is 10 Mbits/sec. In this example, the communication path 300 may be a DS-3 line, which can transmit about 45 Mbits per second. If the total bandwidth capacity of the communication path 300 is only 1.5 Mbits/sec, e.g., for a T-1 line, then the router 302 in FIG. 3 may use the first interface to carry signal traffic (intended for the first reseller 114A) to the tunnel switch 108 using 75% of the 1.5 Mbits/sec that is available for signal traffic.

Likewise, the tunnel switch 108 may use two bandwidth limiting interfaces to control downstream signal traffic from the tunnel switch 108 to the router 302 in accordance with the DSL agreements. The interfaces used by the router 302 may be independent (‘transparent’) from the interfaces used by the tunnel switch 108, and vice versa. In one embodiment, the interfaces operate independently from the L2TP protocol.

When the router 302 and the tunnel switch 108 use interfaces, the number of subscribers 200A, 200B for each reseller 114 and the amount of bandwidth demanded by the subscribers 200A, 200B of each reseller 114 are irrelevant. Once the router 302 and tunnel switch 108 use the interfaces, packet flow between the base station 105 and the ISPs 114A, 114B will follow the bandwidth limiting factors/bottlenecks of the interfaces. Overflow packets may be ‘dropped’ (discarded) by the router 302 or tunnel switch 108 or stored temporarily in a queue (not shown) at the router 302 or tunnel switch 108 until suitable bandwidth becomes available.

The interfaces also enable each reseller 114 in FIG. 3 to control the amount of bandwidth that the reseller 114 leases to their subscribers 200. If one reseller 114A has either (1) more subscribers 200A near a given base station 105 than an allowed number of subscribers or (2) subscribers 200A consuming more bandwidth than the allocated amount, the interface will impact the bandwidth of only that resellers' subscribers 200A.

For example, if the first reseller 114 has 40 subscribers 200A near the base station 105 (instead of 30 subscribers), and the first reseller 114 leases 1 Mbit/second to each subscriber 200A, then the bandwidth of each subscriber 200A will be downgraded to the average of all subscribers 200A of the first reseller 114A. In other words, each subscriber 200A of the first reseller 114A will have a bandwidth of the bandwidth limit/bottleneck (30) divided by the number of actual subscribers 200A (40), which is equal to ¾ of the 1 Mbit/second leased bandwidth. The bandwidth of other resellers' subscribers will not be affected. Thus, the interfaces encourage each reseller 114 to avoid over-subscription.

The above-described embodiments of the present invention are merely meant to be illustrative and not limiting. Various changes and modifications may be made without departing from the invention in its broader aspects. The appended claims encompass such changes and modifications within the spirit and scope of the invention.

What is claimed is:

1. A system for controlling signal transmission between a plurality of modems coupled to computers and at least two Internet service providers, the system comprising:
a router coupled to a base station, the base station being configured to transmit and receive wireless signals to and from the modems coupled to computers; and
a tunnel switch in communication with the router via a communication path, wherein the router is configured to route signals between the base station and the tunnel switch via the communication path, the tunnel switch being configured to route signals between the router and first and second Internet service providers via wired communication paths, the router being configured to impose a first predetermined signal bandwidth limit between the modems and the first Internet service provider, and the router being configured to impose a second pre-determined signal bandwidth limit between the modems and the second Internet service provider.

2. The system of claim 1, wherein the router uses a software interface to impose the first and second pre-determined signal bandwidth limits.

3. The system of claim 1, wherein the router uses a hardware interface to impose the first and second predetermined signal bandwidth limits.

4. The system of claim 1, wherein the router uses a circuit and software to impose the first and second pre-determined signal bandwidth limits.

5. The system of claim 1, wherein the tunnel switch uses a first Layer 2 Tunneling Protocol to direct signals between the first ISP and at least one modem and a second Layer 2 Tunneling Protocol to direct signals between the second ISP and at least one modem.

6. The system of claim 1, wherein the signals between the modems and the base station comprise emails.

7. The system of claim 1, wherein the signals between the modems and the base station comprise requests for Internet content.

8. The system of claim 1, wherein the signals between the modems and the base station comprise motion pictures and requests for motion pictures.

9. The system of claim 1, wherein the signals between the modems and the base station comprise music videos and requests for music videos.

10. The system of claim 1, wherein the signals between the modems and the base station comprise video games and requests for video games.

11. The system of claim 1, wherein the modems and the base station maintain a substantially continuous wireless communication connection.

12. The system of claim 1, wherein the communication paths comprise fiber optic cable.

13. The system of claim 1, wherein the communication paths are wireless.

14. The system of claim 1, wherein the modems are integrated with the computers.

15. The system of claim 1, wherein the router is configured to impose a first pre-determined signal bandwidth limit between the router and the tunnel switch for the first Internet service provider, and the router being configured to impose a second pre-determined signal bandwidth limit between the router and the tunnel switch for the second Internet service provider.

16. A system for controlling signal transmission between a plurality of modems coupled to computers and at least two Internet service providers, the system comprising:
a router coupled to a base station, the base station being configured to transmit and receive wireless signals to and from the modems coupled to computers; and
a tunnel switch in communication with the router via a communication path, wherein the router is configured to route signals between the base station and the tunnel switch via the communication path, the tunnel switch being configured to route signals between the router and first and second Internet service providers via wired communication paths, the tunnel switch being configured to impose a first predetermined signal bandwidth limit between the modems and the first Internet service provider, and the tunnel switch being configured to impose a second pre-determined signal bandwidth limit between the modems and the second Internet service provider.

17. A method of controlling signal transmission between a plurality of modems coupled to computers and at least two Internet service providers, the method comprising:
wirelessly transmitting signals between a base station and the modems coupled to computers;
routing signals between a router coupled to the base station and a tunnel switch via a communication path;
routing signals between the tunnel switch and first and second Internet service providers via wired communication paths;
imposing a first predetermined signal bandwidth limit between the modems and the first Internet service provider; and
imposing a second pre-determined signal bandwidth limit between the modems and the second Internet service provider.

18. The method of claim 17, wherein routing signals between the tunnel switch and first and second Internet service providers uses a first Layer 2 Tunneling Protocol to direct signals between the first ISP and at least one modem and a second Layer 2 Tunneling Protocol to direct signals between the second ISP and at least one modem.

19. The method of claim 17, wherein the signals between the modems and the base station comprise requests for Internet content.

20. The method of claim 17, wherein imposing first and second predetermined signal bandwidth limits comprise:
imposing a first pre-determined signal bandwidth limit between the router and the tunnel switch for the first Internet service provider; and
imposing a second pre-determined signal bandwidth limit between the router and the tunnel switch for the second Internet service provider.

21. A system for controlling signal transmission between a plurality of modems coupled to computers and at least two Internet service providers, the system comprising:
a routing means coupled to a base station, the base station being configured to transmit and receive wireless signals to and from the modems coupled to computers; and
a tunnel switching means in communication with the routing means via a communication path, wherein the routing means is configured to route signals between the base station and the tunnel switching means via the communication path, the tunnel switching means being configured to route signals between the routing means and first and second Internet service providers via wired communication paths, the routing means being configured to impose a first pre-determined signal bandwidth limit between the modems and the first Internet service provider, and the routing means being configured to impose a second pre-determined signal bandwidth limit between the modems and the second Internet service provider.

22. A method of controlling signal transmission between a plurality of modems coupled to computers and at least two Internet service providers, the method comprising:
wirelessly transmitting signals between a base station and the modems coupled to computers;
routing signals between a routing means coupled to the base station and a tunnel switching means via a communication path;
routing signals between the tunnel switching means and first and second Internet service providers via wired communication paths;
imposing a first predetermined signal bandwidth limit between the modems and the first Internet service provider; and
imposing a second pre-determined signal bandwidth limit between the modems and the second Internet service provider.
